(19) United States
(12) Patent Application Publication
(10) Pub. No.: US 2008/0236612 A1
(43) Pub. Date: Oct. 2, 2008

(54) Mask

(76) Inventor: Samson Duke-Obaigbena, Thames Ditton (GB)

Correspondence Address: GORDON & JACOBSON, P.C., 60 LONG RIDGE ROAD, SUITE 407, STAMFORD, CT, 06902, US

(21) Appl. No.: 12/026,948

(22) Filed: Feb. 6, 2008

(30) Foreign Application Priority Data
Mar. 30, 2007 (GB) GB 0706229.2
Jul. 9, 2007 (GB) GB 0713173.3

(51) Int. Cl. A45D 40/30; A61H 33/06

(52) U.S. Cl. 132/319; 4/537

(57) ABSTRACT

A mask for delivering steam to the face and neck of a user. The mask includes an outer layer and an inner layer adapted to cover the face and neck of the user. The outer and inner layers are arranged in a spaced relationship to define a cavity therebetween for receiving steam from a source of steam. The inner layer comprising at least one pore to allow the steam to escape from the cavity through said at least one pore. The mask further comprises a seal formed along its periphery to enable the mask to be held off the face and neck thereby enabling the steam to circulate between the outer surface of the inner layer, and the face and neck.

### CROSS-REFERENCE TO RELATED APPLICATIONS

This application claims priority from UK patent application number GB 0706229.2 filed on Mar. 30, 2007 and UK patent application number GB 0713 173.3 filed on Jul. 9, 2007 both of which are incorporation by reference herein.

### BACKGROUND OF THE INVENTION

1. Field of the Invention

The present invention relates to a mask and particularly, but not exclusively, to a mask for reducing shaving rash.

2. State of the Art

It is well known that shaving the face and neck every day can irritate the skin leading to the so-called shaving rash. However, the shaving rash can be lessened by ensuring the skin and hair bristles are softened with warm water before shaving and subsequently washing the skin after shaving to open pores within the skin.

However, softening the skin and hair bristles is a time consuming process with the result that this process is often performed inadequately. Accordingly, shaving often commences prematurely. Moreover, after shaving, the skin can often feel tight and dry which can lead to further skin irritation and thus a more pronounced shaving rash.

### SUMMARY OF THE INVENTION

In accordance with this invention there is provided a mask for delivering steam to the face and neck of a user. The mask includes an outer layer and an inner layer adapted to cover the face and neck of the user. The outer and inner layers are arranged in a spaced relationship to define a cavity therebetween for receiving steam from a source of steam. The inner layer comprising at least one pore to allow the steam to escape from the cavity through said at least one pore. The mask further comprises a seal formed along its periphery to enable the mask to be held off the face and neck thereby enabling the steam to circulate between the outer surface of the inner layer, and the face and neck.

Preferably, said mask is worn around the face and neck for delivering steam to the face and neck of the user.

Preferably, said seal further acts to prevent the steam from escaping from between the outer surface of the inner layer, and the face and neck.

Preferably, the mask applies steam to the shaved area of the face and neck.

The mask preferably comprises a strap which can pass around the head for securing the mask to the face and neck region. In addition, the mask preferably comprises an opening arranged adjacent to the mouth to permit regular comfortable breathing during use.

The mask preferably further comprises a connector for connecting the mask with said source of steam. The connector is preferably arranged below the chin region of the mask and is in fluid communication with said cavity.

The inner layer preferably comprises a plurality of pores or holes, or may be formed of a porous material, so that the steam can escape from within the mask and circulate close to the skin.

Additional objects and advantages of the invention will become apparent to those skilled in the art upon reference to the detailed description taken in conjunction with the provided figures.

### BRIEF DESCRIPTION OF THE DRAWINGS

FIG. 1 is a front perspective view of an exemplary mask in accordance with the present invention.

FIG. 2 is a cut-away view of the mask of FIG. 1, illustrating the seal that holds off the mask from the face and neck of the user.

FIG. 3 is a view illustrating the mask of FIG. 1 secured to the head of a user.

### DETAILED DESCRIPTION

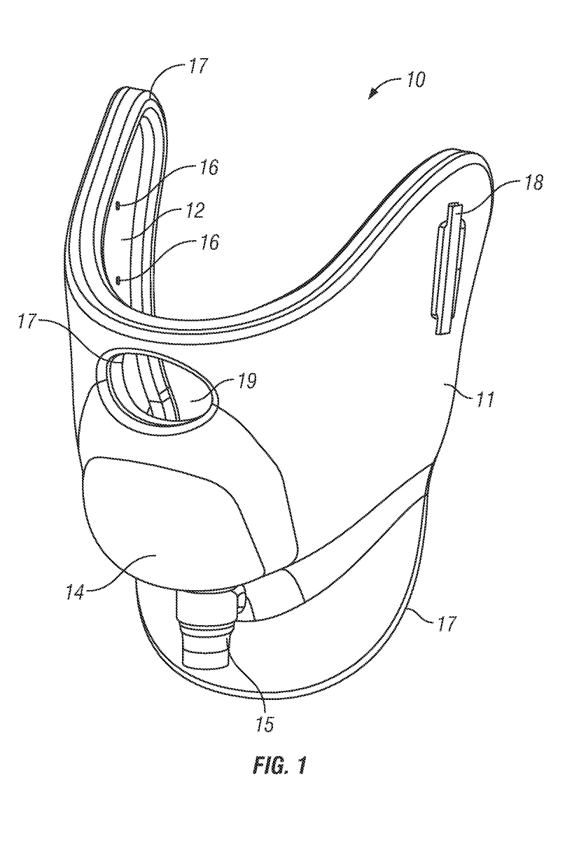

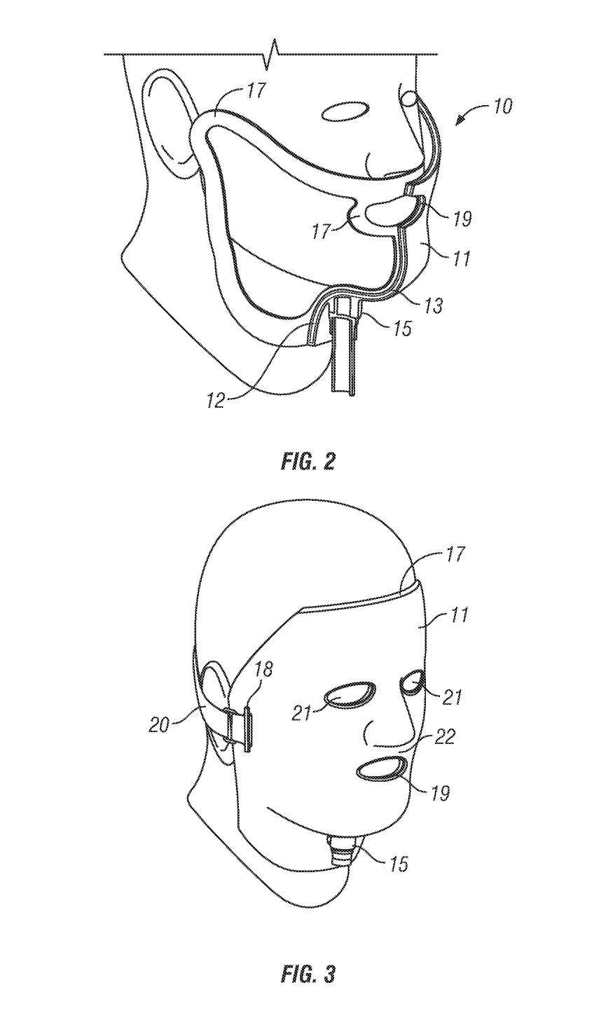

Turning now to FIG. 1, there is shown a mask 10 for directing steam to the shaved area of the face and neck. The mask 10 comprises an outer protective layer 11 and an inner layer 12 separated from the outer protective layer 11 by a cavity 13.

The outer layer 11 and inner layer 12 are contoured to accommodate the features of the face and neck and are arranged to cover the shaved areas of the face and neck. Alternatively, the mask may be arranged to further cover the entire face.

Beneath the chin region 14 of the mask 10, there is provided a connector for connecting the cavity region 13 of the mask 10 with a source of steam (not shown). The source of steam (not shown), such as a temperature controlled steam unit is arranged to connect with the connector 15 to enable steam to pass into the cavity 13 of the mask 10 through the connector 15.

The inner layer 12 is formed with a plurality of small holes or pores 16, which extend through the inner layer 12 and enable the steam within the cavity 13 to pass out of the cavity 13 and circulate close to the skin.

The periphery of the mask 10 is provided with a rubber seal 17 which provides a sealing engagement with the face and holds the outer surface of the inner layer 12 off the face so that the steam can pass out of the cavity 13 through the pores 16 and circulate around the shaved area of the skin. In this manner, the steam acts to soften the skin and bristles before shaving and when used after shaving, the steam can help open pores in the skin to lessen the rash caused by shaving. Furthermore, infusing herbs and/or aromatherapy oils within the steam is known to improve the emollient effect. Liquorice root is the favoured herb because it helps open the pores, soothe, cleanse, and lubricate the skin. Others such as tea tree oil can help to provide an antibacterial and anti-inflammatory effect.

The mask may further comprise an opening 19 adjacent the mouth area of a person's face so that the person can breathe as normal during use. In addition, if the mask is used to direct steam to the entire face, then further apertures 21, 22 can be provided near the eye and nose region, respectively.

The further provision of a strap 20 and a strap attachment 18 enables the mask 10 to be worn freely about the face and neck, by passing the strap 20 around the back of the head and securing the strap 20 to the strap attachment 18.

From the foregoing therefore, it is evident that the mask of the present invention provides a simple yet effective means of softening the skin and opening pores within the skin, to help reduce shaving rash. In addition, while the present invention has been exemplified here with reference to reducing the effects of shaving rash, it is also apparent that the mask of the present invention could also be used to cleanse and rejuvenate the skin.

There have been described and illustrated herein several embodiments of a mask 10 for directing steam to the face and neck. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A mask for delivering steam to the face and neck of a user, said mask comprising:
an outer layer and an inner layer adapted to cover the face and neck of the user, said outer and inner layer arranged in a spaced relationship to define a cavity therebetween for receiving steam from a source of steam, said inner layer comprising at least one pore to allow said steam to escape from said cavity through said at least one pore; and
a seal formed along periphery of inner layer to enable said inner layer to be held off the face and neck thereby enabling the steam to circulate between the outer surface of the inner layer and the face and neck.

2. A mask according to claim 1, further comprising:
support means for supporting said mask on the head of the user.

3. A mask according to claim 2, wherein:
said support means comprises a strap that is adapted to pass around the head of the user.

4. A mask according to claim 1, wherein:
said seal further acts to prevent the steam from escaping from between the outer surface of the inner layer and the face and neck.

5. A mask according to claim 1, wherein:
said mask applies steam to a shaved area portion of the face and neck.

6. A mask according to claim 1, further comprising:
a strap which can pass around the head for securing the mask to the face and neck.

7. A mask according to claim 1, further comprising:
an opening in said outer and inner layers, said opening operably disposed adjacent to the mouth of the user to permit regular comfortable breathing during use.

8. A mask according to claim 1, further comprising:
a connector for connecting the mask with said source of steam.

9. A mask according to claim 8, wherein:
said outer layer and inner layer have a chin region that covers the chin of the user, and said connector is disposed below said chin region of the said outer and inner layer.

10. A mask according to claim 8, wherein:
said connector is in fluid communication with said cavity.

11. A mask according to claim 1, wherein:
said inner layer comprises a plurality of pores or holes so that the steam can escape from within the mask and circulate close to the skin.

12. A mask according to claim 1, wherein:
said inner layer is formed of a porous material.
